(19) United States
(12) Patent Application Publication
(10) Pub. No.: US 2023/0376564 A1
(43) Pub. Date: Nov. 23, 2023

(54) ESTIMATION METHOD, ESTIMATION APPARATUS AND PROGRAM

(71) Applicant: NIPPON TELEGRAPH AND TELEPHONE CORPORATION, Tokyo (JP)

(72) Inventors: Yasunori AKAGI, Tokyo (JP); Naoki MARUMO, Tokyo (JP); Takeshi KURASHIMA, Tokyo (JP); Hiroyuki TODA, Tokyo (JP)

(21) Appl. No.: 18/247,942

(22) PCT Filed: Nov. 5, 2020
(86) PCT No.: PCT/JP2020/041426

§ 371 Date: Apr. 5, 2023

(51) Int. Cl. G06F 17/18

(52) U.S. Cl. CPC G06F 17/18

(57) ABSTRACT

An estimation method according to an embodiment is an estimation method that estimates a MAP solution of a CGM on a path graph, in which a computer executes: an input procedure that receives, as inputs, aggregate data and potentials of the CGM on the path graph; an estimation procedure that uses the aggregate data and the potentials to solve a MAP estimation problem of the CGM by a technique based on discrete DC programming and calculates a MAP estimation solution; and an output procedure that outputs the MAP estimation solution.

### TECHNICAL FIELD

The present invention relates to an estimation method, an estimation apparatus, and a program.

### BACKGROUND ART

These days, with the development of sensors and information communication technologies, various data have been collected on a large scale; however, it is often the case that not individual data but aggregated data alone is available due to consideration for privacy, difficulty in observation, etc. For example, human position information obtained by observing radio waves from a GPS (Global Positioning System) satellite may be provided as time-based area population data in which individuals cannot be tracked in consideration for privacy. The time-based area population data is information indicating the number of people in each area at each time step.

A model called a CGM (Collective Graphical Model) is known and widely used as a model with which even in a situation where only thus aggregated data (hereinafter, also referred to as aggregate data) is available, deeper information can be extracted from the data by performing interpolation, estimation, and learning on the basis of probabilistic modeling (see, for example, Non Patent Literature 1).

Among operations in the CGM, there is an operation in which when observed aggregate data and potentials of a graphical model present behind it are given, a true contingency table of the graphical model is estimated by MAP estimation (maximum a posteriori estimation). The MAP estimation is essential for interpolation and estimation, and is a very important operation used also as a subroutine of learning; thus, has been variously studied heretofore.

### CITATION LIST

### Non Patent Literature

Non Patent Literature 1: D. R. Sheldon and T. G. Dietterich. Collective Graphical Models. In Proceedings of the 24th International Conference on Neural Information Processing Systems, pp. 1161-1169, 2011

### SUMMARY OF INVENTION

### Technical Problem

Meanwhile, when estimating a true contingency table of a graphical model by MAP estimation, it is necessary to solve a MAP estimation problem. At this time, conventionally, a technique of solution by applying Stirling's approximation and continuous relaxation has been mainly used. However, this technique may have low solution accuracy or low solution interpretability.

An embodiment of the present invention has been made in view of the above points, and an object of the present invention is to obtain a MAP estimation solution with high accuracy and high interpretability.

### Solution to Problem

Aiming to achieve the above object, an estimation method according to an embodiment is an estimation method that estimates a MAP solution of a CGM on a path graph, in which a computer executes: an input procedure that receives, as inputs, aggregate data and potentials of the CGM on the path graph; an estimation procedure that uses the aggregate data and the potentials to solve a MAP estimation problem of the CGM by a technique based on discrete DC programming and calculates a MAP estimation solution; and an output procedure that outputs the MAP estimation solution.

### Advantageous Effects of Invention

A MAP estimation solution with high accuracy and high interpretability can be obtained.

### BRIEF DESCRIPTION OF DRAWINGS

FIG. 1 is a diagram showing an example of a minimum cost flow problem.

FIG. 2 is a diagram showing an example of a hardware configuration of a MAP estimation apparatus according to the present embodiment.

FIG. 3 is a diagram showing an example of a functional configuration of a MAP estimation apparatus according to the present embodiment.

FIG. 4 is a diagram showing an example of potentials.

FIG. 5 is a diagram showing an example of aggregate data.

FIG. 6 is a diagram showing an example of a MAP estimation solution.

FIG. 7 is a flowchart showing an example of MAP estimation processing according to the present embodiment.

FIG. 8 is a flowchart showing an example of the processing of calculating a MAP estimation solution by a technique based on discrete DC programming according to the present embodiment.

### DESCRIPTION OF EMBODIMENTS

Hereinbelow, an embodiment of the present invention is described. In the present embodiment, a MAP estimation apparatus 10 is described with which when observed aggregate data and potentials of a graphical model are given and it is attempted to estimate a true contingency table of the graphical model by MAP estimation, a MAP estimation solution with high accuracy and high interpretability can be obtained.

<CGM and MAP Estimation>

First, a CGM and MAP estimation are briefly described.

Letting H=(N, A) be an undirected graph, a graphical model expressed by a probability mass function like below will now be considered. Note that N is a set of vertices, and A is a set of edges.

$$\begin{matrix}p ( x ; θ ) = Pr ( X = x ; θ ) \\ = \frac{1}{Z ( θ )} {\prod }_{( i , j ) ∈ A} {ϕ}_{ij} ( {x}_{i} , {x}_{j} ; θ )\end{matrix} \qquad [ Math . 1 ]$$

where φᵢⱼ(xᵢ, xⱼ|θ) is a local potential defined for variables (Xᵢ, Xⱼ). The local potential is controlled by a parameter vector θ, and Z(θ) is a normalization constant (partition function). It is assumed that the random variable Xᵢ takes a value in a finite set

xᵢ [Math. 2]

Samples from this graphical model are represented by x⁽¹⁾, . . . , x^{(M)}. A contingency table nᵢ regarding a vertex i and a contingency table nᵢⱼ regarding an edge (i, j) are defined as follows, respectively.

$$\begin{matrix}{n}_{i} = ( {n}_{i} ( {x}_{i} ) \vert {x}_{i} ∈ {χ}_{i} ) \\ {n}_{ij} = ( {n}_{ij} ( {x}_{i} , {x}_{j} ) \vert {x}_{i} ∈ {χ}_{i} , {x}_{j} ∈ {χ}_{j} ) where & [ Math . 3 ] \\ {n}_{i} ( {x}_{i} ) = {\sum }_{m = 1}^{M} 𝕀 ( {X}_{i}^{( m )} = {x}_{i} ) \\ {n}_{i} ( {x}_{i} , {x}_{j} ) = {\sum }_{m = 1}^{M} 𝕀 ( {X}_{i}^{( m )} = {x}_{i} , {X}_{j}^{( m )} = {x}_{j} ) & [ Math . 4 ]\end{matrix}$$

provided that

[symbol]

(⋅) [Math. 5]

is an indicator function. Further, a vector in which the contingency table nᵢ regarding the vertex i and the contingency table nᵢⱼ regarding the edge (i, j) are collected and arranged for all the vertices and all the edges is represented by n.

At this time, a distribution of n (this is referred to as a CGM distribution) can be written as

$$p ( n ; θ ) = M ! \cdot \frac{{\prod }_{i ∈ N} {\prod }_{{z}_{i} ∈ {ϰ}_{i}} {( {n}_{i} ( {x}_{i} ) ! )}^{{υ}_{i} - 1}}{{\prod }_{( i , j ) ∈ A} {\prod }_{{x}_{i} ∈ {χ}_{i} , {z}_{j} ∈ {χ}_{j}} {n}_{ij} ( {x}_{i} , {x}_{j} ) !} \cdot g ( n , θ ) \cdot 𝕀 ( n ∈ {𝕃}_{M}^{ℤ} ) \qquad [ Math . 6 ]$$

$$g ( n , θ ) = \frac{1}{Z ( {θ )}^{M}} {\prod }_{( i , j ) ∈ A} {\prod }_{{x}_{i} , {x}_{j}} {ϕ ( {x}_{i} {x}_{j} θ )}^{{n}_{ij} ( {x}_{i} , {x}_{j} )}$$

$${𝕃}_{m}^{ℤ} = \{ n ∈ {ℤ}_{\geq 0}^{\vert n \vert} \vert M = {\sum }_{{x}_{i}} {n}_{i} ( {x}_{i} ) ∀ i ∈ N , {n}_{i} ( {x}_{i} ) = {\sum }_{{x}_{j}} {n}_{ij} ( {x}_{i} , {x}_{j} ) ∀ ∈ N , {x}_{i} ∈ {χ}_{i} , j ∈ N ( i ) \} ,$$

where νᵢ is the degree of the vertex i.

Further, it is assumed that an observation value y (that is, observed aggregate data) is generated from some probability distribution p(y|n) indicating observation noise. Specifically, it is assumed that the value nᵢ is observed at each vertex in accordance with the following observation noise model.

$${p}_{node} ( y \vert n ) = {\prod }_{i ∈ N , {x}_{i}} {p}_{i , {x}_{i}} ( {y}_{i} ( {x}_{i} ) \vert {n}_{i} ( {x}_{i} ) ) \qquad [ Math . 7 ]$$

provided that it is assumed that

−log p_{i,x}_{ᵢ}(yᵢ(xᵢ)|nᵢ(xᵢ)) [Math. 8]

is a convex function with respect to nᵢ(xᵢ). A posterior distribution of n is given by p(n|y; θ)∝p(n; θ)·p(y|n). Then, a MAP estimation problem is expressed as maxₙp(n|y; θ).

The above MAP estimation problem will now be modified. When the MAP estimation problem is regarded as a minimization problem of −log p(n|y; θ), the following minimization problem is to be solved.

$${min}_{n} . ℒ ( n ) \\ s . t . M = {\sum }_{{x}_{i}} {n}_{i} ( {x}_{i} ) ( ∀ i ∈ N ) \\ {n}_{i} ( {x}_{i} ) = {\sum }_{{x}_{j}} {n}_{ij} ( {x}_{i} , {x}_{j} ) ( ∀ ( i , j ) ∈ A , ∀ {x}_{i} ∈ {χ}_{i} ) \\ {n}_{i} ( {x}_{i} ) ∈ {ℤ}_{\geq 0} ( ∀ i ∈ N , ∀ {x}_{i} ∈ {χ}_{i} ) \\ {n}_{ij} ( {x}_{ij} ) ∈ {ℤ}_{\geq 0} ( ∀ ( i , j ) ∈ A , ∀ {x}_{i} ∈ {χ}_{i} , ∀ {x}_{j} ∈ {χ}_{j} ) \\ where \qquad [ Math . 9 ]$$

$$ℒ ( n ) := {\sum }_{( i , j ) ∈ A} {\sum }_{{x}_{i} ∈ {χ}_{i}} {\sum }_{{x}_{j} ∈ {χ}_{j}} [ log {n}_{ij} ( {x}_{i} , {x}_{j} ) ! - {n}_{ij} ( {x}_{i} , {x}_{j} ) log {ϕ}_{i , j} ( {x}_{i} , {x}_{j} ) ] - {\sum }_{i ∈ N} {\sum }_{{x}_{i} ∈ {χ}_{i}} ( {v}_{i} - 1 ) log {n}_{i} ( {x}_{i} ) ! - {\sum }_{i ∈ N} {\sum }_{{x}_{i} ∈ {χ}_{i}} log [ {p}_{i , {x}_{i}} ( {y}_{i} ( {x}_{i} ) \vert {n}_{i} ( {x}_{i} ) ) ] \qquad [ Math . 10 ]$$

Hereinafter, for simplicity, it is assumed that, for i=1, 2, . . . , |N|,

xᵢ={1, 2, . . . , R}. [Math. 11]

Note that this is an example, and the following description can be easily extended to other cases.

The MAP estimation problem shown in Math. 9 above is generally considered to be NP-hard, and is therefore very difficult to solve efficiently. For this reason, conventionally, a technique in which Stirling's approximation and continuous relaxation (that is, removal of the restriction of taking only integer values) are applied to the objective function and message passing is used to make solution, or the like has been mainly used. The continuously relaxed problem is a convex programming problem, and a global optimum solution can be obtained by message passing (see, for example, Reference 1).

Reference 1: T. Sun, D. R. Sheldon and A. Kumar. Message Passing for Collective Graphical Model. In Proceedings of the 32nd International Conference on Machine Learning, pp. 853-861, 2015.

However, the conventional technique described above has the following two problems of (1) and (2).
(1) When the total number of samples M is small, a solution significantly deviating from the correct solution is outputted. This is due to the fact that Stirling's approximation

log x!≠x log x−x [Math. 12]

is not accurate when x is small.
(2) The outputted solution is not sparse; hence, interpretation is difficult, and furthermore a large amount of memory is needed to hold the solution. This is because solutions other than integers are outputted due to the application of continuous relaxation.

Thus, in the present embodiment, a case is described where the MAP estimation of a CGM in a path graph is brought down to a minimum cost flow problem on a network and discrete DC (Difference of Convex) programming is applied to this problem to efficiently solve the estimation of n without approximation or continuous relaxation. Thereby, the MAP estimation apparatus 10 according to the present embodiment can output an accurate solution even when the total number of samples M is small, and can output a sparse solution (that is, a solution with high interpretability). The CGM in a path graph is important because it can express a time-series model (Markov model) and therefore has a wide application range.

Note that the discrete DC programming is a technique of efficiently optimizing a function expressed in the form of a difference between two discrete convex functions (see, for example, Reference 2).

Reference 2: T. Maehara, K. Murota, A framework of discrete DC programming by discrete convex analysis. Mathematical Programming, Series A, vol. 152, no. 1-2, pp. 435-466.

<Theoretical Configuration of MAP Estimation According to the Present Embodiment>

Next, a theoretical configuration when the MAP estimation apparatus 10 according to the present embodiment performs MAP estimation is described. As described above, the MAP estimation apparatus 10 according to the present embodiment brings the MAP estimation of a CGM in a path graph down to a minimum cost flow problem on a network, and then applies discrete DC programming to this problem to make solution; thus, obtains a MAP estimation solution.

First, the minimum cost flow problem is described. The (non-linear) minimum cost flow problem is a problem like below. A directed graph G=(V, E) is given as an input, and for each edge (i, j)∈E,

Capacity constraint uᵢⱼ∈ [symbol] ≥₀

Cost function cᵢⱼ: [symbol] ≥₀→ [symbol] [Math. 13]

are allocated. Further, for each vertex i∈V,

Demand bᵢ∈ [symbol] ≥₀ [Math. 14]

is given. The minimum cost flow problem is a problem of obtaining a flow having the minimum cost among flows satisfying the capacity constraint of each edge and the demand constraint of each vertex.

That is, when the flow flowing through the edge (i, j)∈E is represented by xᵢⱼ, the minimum cost flow problem can be formulated as follows.

$${min}_{∞ ∈ {ℤ}^{\vert E \vert}} . {\sum }_{( i , j ) ∈ E} {c}_{ij} ( {x}_{ij} ) \\ s . t . {\sum }_{j : ( i , j ) ∈ E} {x}_{ij} - {\sum }_{j : ( j , i ) ∈ E} {x}_{ji} = {b}_{i} ( i ∈ V ) \\ 0 \leq {x}_{ij} \leq {u}_{ij} ( ( i , j ) ∈ E ) \qquad [ Math . 15 ]$$

Here, when the cost function satisfies a convex cost condition of Cᵢⱼ(x+2)+cᵢⱼ(x)≥2·cᵢⱼ(x+1) in all the edges (i, j)∈E, the minimum cost flow problem shown in Math. 15 above is called a minimum convex cost flow problem, and is known to have an efficient solution method.

Next, a method for creating an instance of a minimum cost flow problem is described. For ease of writing, the notation of

nᵢⱼₖ:=n_{i, i+1}(j, k)

φᵢⱼₖ:=φ_{i, i+1}(j, k)

nᵢ:=nᵢ(j)

yᵢ:=yᵢ(j)

is used. When the graphical model is of a path type,

$${v}_{i} = \{ \begin{matrix}1 & ( i = 1 , \vert N \vert ) \\ 2 & ( otherwise )\end{matrix} , \qquad [ Math . 16 ]$$

and thus the objective function is

$$ℒ ( n ) := {{\sum }_{i = 1}}^{\vert N \vert - 1} {{\sum }_{j = 1}}^{R} {{\sum }_{k = 1}}^{R} [ log {n}_{ijk} ! - {n}_{ijk} \cdot log {ϕ}_{ijk} ] - {{\sum }_{i = 2}}^{\vert N \vert - 1} {{\sum }_{j = 2}}^{R} log {n}_{ij} ! - {{\sum }_{i = 1}}^{\vert N \vert - 1} {{\sum }_{j = 1}}^{R} log [ {p}_{i , j} ( {y}_{ij} \vert {n}_{ij} ) ] . \qquad [ Math . 17 ]$$

Further, letting

fᵢⱼₖ(z):=log z!−z·log φᵢⱼₖ

g(z):=−log z!

hᵢⱼ(z):=−log [pᵢⱼ(yᵢⱼ|z)],

the objective function can be rewritten as

$$ℒ ( n ) := {{\sum }_{i = 1}}^{\vert N \vert - 1} {{\sum }_{j = 1}}^{R} {{\sum }_{j = 1}}^{R} {f}_{ijk} ( {n}_{ijk} ) - {{\sum }_{i = 2}}^{\vert N \vert - 1} {{\sum }_{j = 1}}^{R} g ( {n}_{ij} ) - {{\sum }_{i = 1}}^{\vert N \vert - 1} {{\sum }_{j = 1}}^{R} {h}_{ij} ( {n}_{ij} ) \qquad [ Math . 18 ]$$

In order to turn the optimization problem estimation problem) shown in Math. 9 above into a minimum cost flow problem, a minimum cost flow problem on the graph G=(V, E) is constructed by (a) to (g) below. Note that in the following description, the edge (c, u) represents an edge in which the cost function is c and the capacity constraint is u. Further, [m]=(1, 2, . . . , m) is given for any natural number m.
(a) Let the vertex set V be as follows.

V={o}∪( [symbol] ⁽¹⁾∪ [symbol] ⁽¹⁾)∪( [symbol] ⁽²⁾∪ [symbol] ⁽²⁾). . . ∪( [symbol] ^{(|N|)}∪ [symbol] ^{(|N|)})∪{d} [Math. 19]

where

[symbol]

⁽ⁱ⁾:={uⱼ⁽ⁱ⁾}ⱼ₌₁^{R}; [symbol] ⁽ⁱ⁾:={vⱼ⁽ⁱ⁾}ⱼ₌₁^{R} [Math. 20].

Further, o is the vertex forming the start point of the flow, and d is the vertex forming the end point of the flow.
(b) For j∈[R], stretch an edge (0, +∞) from vertex o to vertex uⱼ⁽¹⁾.
(c) For j∈[R], stretch an edge (0, +∞) from vertex vⱼ^{(|N|)} to vertex d.
(d) For i=1, |N|, and j∈[R], stretch an edge (hᵢⱼ(z), +∞) from vertex uⱼ⁽ⁱ⁾ to vertex vⱼ⁽ⁱ⁾.
(e) For i=2, . . . , |N|−1, and j∈[R], stretch an edge (hᵢⱼ(z)+g(z), +∞) from vertex uⱼ⁽ⁱ⁾ to vertex vⱼ⁽ⁱ⁾.
(f) For i∈[|N|−1], j∈[R], and k∈[R], stretch an edge (fᵢⱼₖ(z), +∞) from vertex vⱼ⁽ⁱ⁾ to vertex uₖ⁽ⁱ⁺¹⁾.
(g) Let bₒ=M, b_{d}=−M, and bᵥ=0, where v is a vertex other than o or d, that is:

v∈V\{o, d} [Math. 21]

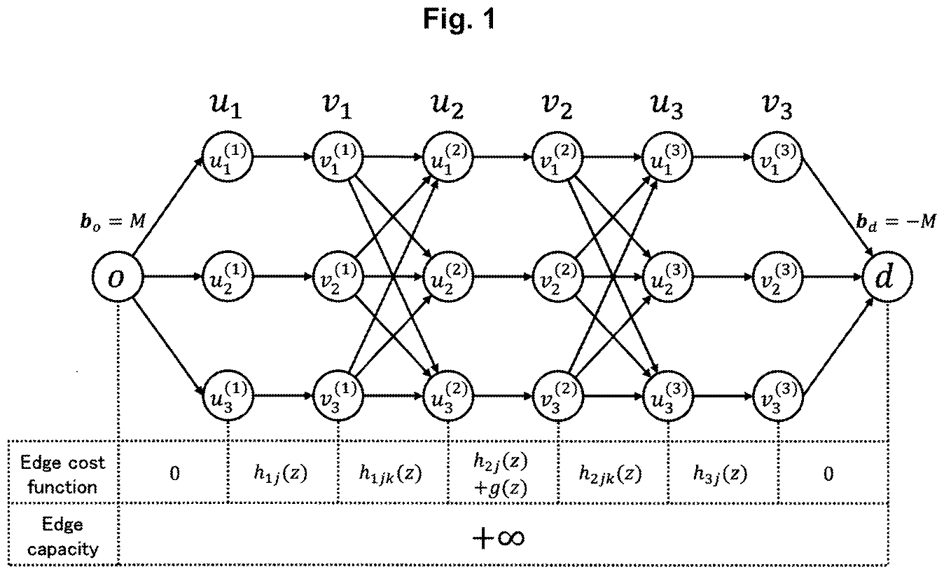

As an example, an instance of a minimum cost flow problem constructed by (a) to (g) above when |N|=3 and R=3 is shown in FIG. 1.

Then, from an optimum solution of a minimum cost flow problem constructed by (a) to (g) above, a solution n* of the optimization problem shown in Math. 9 above is composed as follows.

nᵢⱼₖ*=(Flow rate through an edge from vertex vⱼ⁽ⁱ⁾ to vertex uₖ⁽ⁱ⁺¹⁾)

nᵢⱼ*=(Flow rate through an edge from vertex uⱼ⁽ⁱ⁾ to vertex vⱼ⁽ⁱ⁾) [Math. 22]

At this time, n* is an optimum solution of the optimization problem shown in Math. 9 above. Thus, it can be seen that the MAP estimation of a CGM can be made by solving a minimum cost flow problem constructed by (a) to (g) above.

Although the minimum cost flow problem constructed by (a) to (g) above does not satisfy the convex cost condition, the minimum cost flow problem has a feature that the cost function of the edge has succeeded in being explicitly separated into a convex function and a concave function. Utilizing this, the minimum cost flow problem constructed by (a) to (g) above will now be solved by a technique based on discrete DC programming.

The minimum cost flow problem constructed by (a) to (g) above can be formulated as an optimization problem like below.

$$\begin{matrix}{min}_{x} . ℒ ( z ) = ℱ ( z ) + 𝒢 ( z ) \\ s . t . z ∈ 𝒩 where & [ Math 23 ] \\ ℱ ( z ) = {{\sum }_{i = 1}}^{\vert N \vert - 1} {{\sum }_{j = 1}}^{R} {{\sum }_{j = 1}}^{R} {f}_{ijk} ( {z}_{ijk} ) + {{\sum }_{i = 1}}^{\vert N \vert} {{\sum }_{j = 1}}^{R} {h}_{ij} ( {z}_{ij} ) \\ 𝒢 ( z ) = {{\sum }_{i = 2}}^{\vert N \vert - 1} {{\sum }_{j = 1}}^{R} g ( {z}_{ij} ) & [ Math . 24 ]\end{matrix}$$

### Further,

[symbol] [Math. 25]

is a set of feasible integer solutions of the minimum cost flow problem constructed by (a) to (g) above.

In order to solve the optimization problem shown in Math. 23 above, in a row of feasible solutions zₒ, z₁, . . . , zₜ, . . . , solutions satisfying

[symbol]

(z₀)≥ [symbol] (z₁)≥ . . . ≥ [symbol] (zₜ) . . . [Math. 26]

will now be generated. The initial point

z₀∈ [symbol] [Math. 27]

is arbitrarily taken. When z₀, z₁, . . . , zₜ are already determined, for

(Condition 1) [symbol] (zₜ)= [symbol] (zₜ)

(Condition 2) [symbol] (z)≥ [symbol] (z), ∀z∈

[symbol]

(Condition 3) [symbol] ₜ(z):= [symbol] (z)+ [symbol] (z) [Math. 28]

can be efficiently minimized in N,

a function satisfying all of these,

[symbol]

[Math. 29]

is found. Then, based on

$${z}_{t + 1} = {arg min}_{x ∈ 𝒩} {ℒ}_{t} ( z ) , \qquad [ Math . 30 ]$$

a new point zₜ₊₁ is determined. At this time,

$$\begin{matrix}ℒ ( {z}_{t + 1} ) = ℱ ( {z}_{t + 1} ) + 𝒢 ( {z}_{t + 1} ) \\ \leq ℱ ( {z}_{t + 1} ) + {ℋ}_{t} ( {z}_{t + 1} ) \\ \leq ℱ ( {z}_{n} ) + {ℋ}_{t} ( {z}_{n} ) \\ = ℱ ( {z}_{n} ) + 𝒢 ( {z}_{n} ) \\ = ℒ ( {z}_{t} )\end{matrix} \qquad [ Math . 31 ]$$

holds; thus, it can be seen that the objective function monotonically decreases. Since the set of feasible solutions is a finite set, zₜ is a local optimum solution at a sufficiently large t.

A method for determining, for zₜ,

[symbol]

[Math. 32]

will now be described. For any

w∈ [symbol] ≥₀ [Math. 33]

g̅_{w}(z):=α_{w}·(w−z)−log (z!) [Math. 34]

is given, where α_{w} is any real number satisfying −log (w+1)≤α_{w}≤−log w. At this time,

g̅_{w}(w)=g(w)

g̅_{w}(z)≥g(z) ∀z∈ [symbol] [Math. 35]

hold. Thus, when, for zₜ,

$${\overline{𝒢}}_{t} ( z ) := {{\sum }_{i = 2}}^{\vert N \vert - 1} {{\sum }_{j = 1}}^{R} {\overline{g}}_{{z}_{t , ij}} ( {z}_{ij} ) \qquad [ Math . 36 ]$$

is set,

[symbol]

(zₜ)= [symbol] (zₜ)

[symbol]

(z)≥ [symbol] (z), ∀z∈ [symbol] , [Math. 37]

and conditions 1 and 2 above are satisfied. Further, the problem of minimizing

[symbol]

(z):= [symbol] (z)+ [symbol] (z) [Math. 38]

in a set of feasible solutions,

[symbol]

, [Math. 39]

is a minimum convex cost flow problem; thus, a minimum solution can be efficiently obtained, and condition 3 above is satisfied. Thus,

[symbol]

:= [symbol] ₜ [Math. 40]

may be set.

In view of the above, in order to solve a minimum cost flow problem constructed by (a) to (g) above, a technique based on discrete DC programming is used and the cost function of an edge stretched from vertex uⱼ⁽ⁱ⁾ to vertex vⱼ⁽ⁱ⁾ in graph G is replaced with

hᵢⱼ(z)+g̅_{z}_{_{t, ij}} (z) [Math. 41]

(in other words, the cost function is corrected (or approximated)), and then the minimum convex cost flow problem shown in Math. 30 above is solved to obtain zₜ₊₁. Then, when zₜ₊₁ converges (that is, when the value of the objective function does not change), zₜ₊₁ at this time is outputted as an optimum solution of the minimum cost flow problem constructed by (a) to (g) above (that is, an optimum solution (MAP estimation solution) of the optimization problem shown in Math. 9 above).

<Hardware Configuration>

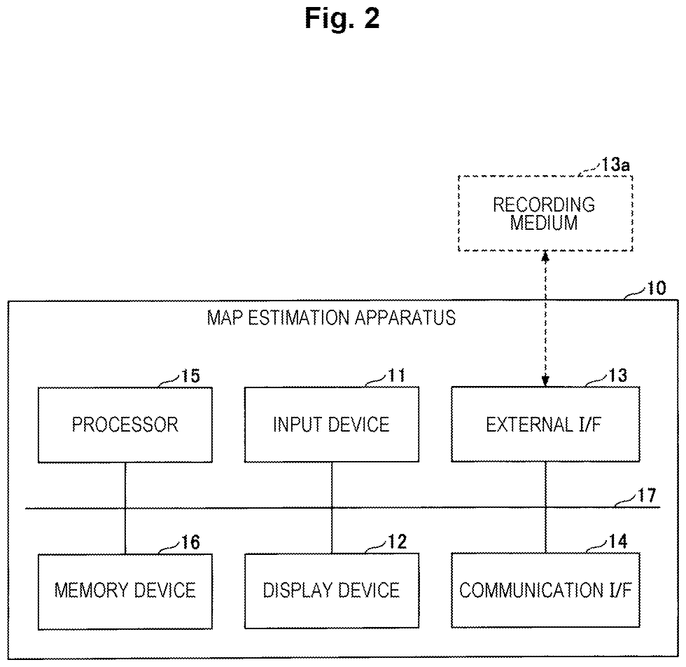

Next, a hardware configuration of the MAP estimation apparatus 10 according to the present embodiment is described with reference to FIG. 2. FIG. 2 is a diagram showing an example of a hardware configuration of the MAP estimation apparatus 10 according to the present embodiment.

As shown in FIG. 2, the MAP estimation apparatus 10 according to the present embodiment is obtained by using a hardware configuration of a general computer or computer system, and includes an input device 11, a display device 12, an external I/F 13, a communication I/F 14, a processor 15, and a memory device 16. These pieces of hardware are connected via a bus 17 to be able to communicate with each other.

The input device 11 is, for example, a keyboard, a mouse, a touch panel, or the like. The display device 12 is, for example, a display or the like. The MAP estimation apparatus 10 may not include both of the input device 11 and the display device 12, for example.

The external I/F 13 is an interface with an external device such as a recording medium 13a. The MAP estimation apparatus 10 can perform reading, writing, etc. of the recording medium 13a via the external I/F 13. Examples of the recording medium 13a include a CD (compact disc), a DVD (digital versatile disk), an SD memory card (Secure Digital memory card), a USB (Universal Serial Bus) memory card, and the like.

The communication I/F 14 is an interface for connecting the MAP estimation apparatus 10 to a communication network. The processor 15 is, for example, an arithmetic device of various types such as a CPU (central processing unit) and a GPU (graphics processing unit). The memory device 16 is, for example, a storage device of various types such as an HDD (hard disk drive), an SSD (solid state drive), a RAM (random access memory), a ROM (read-only memory), and a flash memory.

By having the hardware configuration shown in FIG. 2, the MAP estimation apparatus 10 according to the present embodiment can implement MAP estimation processing described later. Note that the hardware configuration shown in FIG. 2 is an example, and the MAP estimation apparatus 10 may have another hardware configuration. For example, the MAP estimation apparatus 10 may include a plurality of processors 15, and may include a plurality of memory devices 16.

<Functional Configuration>

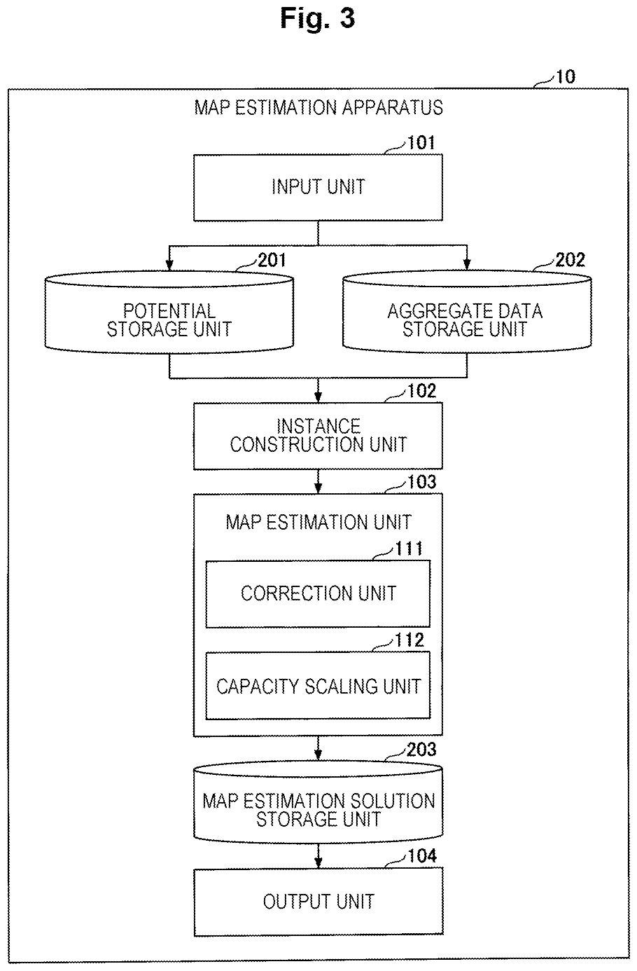

Next, a functional configuration of the MAP estimation apparatus 10 according to the present embodiment is described with reference to FIG. 3. FIG. 3 is a diagram showing an example of a functional configuration of the MAP estimation apparatus 10 according to the present embodiment.

As shown in FIG. 3, the MAP estimation apparatus 10 according to the present embodiment includes an input unit 101, an instance construction unit 102, a MAP estimation unit 103, and an output unit 104. These units are implemented by, for example, processing that one or more programs installed in the MAP estimation apparatus 10 cause the processor 15 to execute.

Further, the MAP estimation apparatus 10 according to the present embodiment includes a potential storage unit 201, an aggregate data storage unit 202, and a MAP estimation solution storage unit 203. These units are obtained by using, for example, the memory device 16. At least one storage unit among these units may be obtained by using, for example, a storage device (a database server or the like) connected to the MAP estimation apparatus 10 via a communication network.

The input unit 101 stores (local) potentials and aggregate data provided to the MAP estimation apparatus 10 in the potential storage unit 201 and the aggregate data storage unit 202, respectively. The input unit 101 may perform correction, etc. of potentials stored in the potential storage unit 201 or aggregate data stored in the aggregate data storage unit 202 in accordance with, for example, an operation or the like from the input device 11.

The instance construction unit 102 constructs (an instance of) a minimum cost flow problem on the basis of (a) to (g) above by using potentials stored in the potential storage unit 201 and aggregate data stored in the aggregate data storage unit 202.

The MAP estimation unit 103 calculates a MAP estimation solution from a minimum cost flow problem constructed by the instance construction unit 102, and stores the MAP estimation solution in the MAP estimation solution storage unit 203. Here, the MAP estimation unit 103 includes a correction unit 111 and a capacity scaling unit 112. The correction unit 111 corrects (or replaces or approximates) the cost function of an edge stretched from vertex uⱼ⁽ⁱ⁾ to vertex vⱼ⁽ⁱ⁾ in graph G. The capacity scaling unit 112 solves the minimum convex cost flow problem shown in Math. 30 above to calculate a solution n*=zₜ₊₁.

The output unit 104 outputs a MAP estimation solution n* stored in the MAP estimation solution storage unit 203 to an arbitrary output destination.

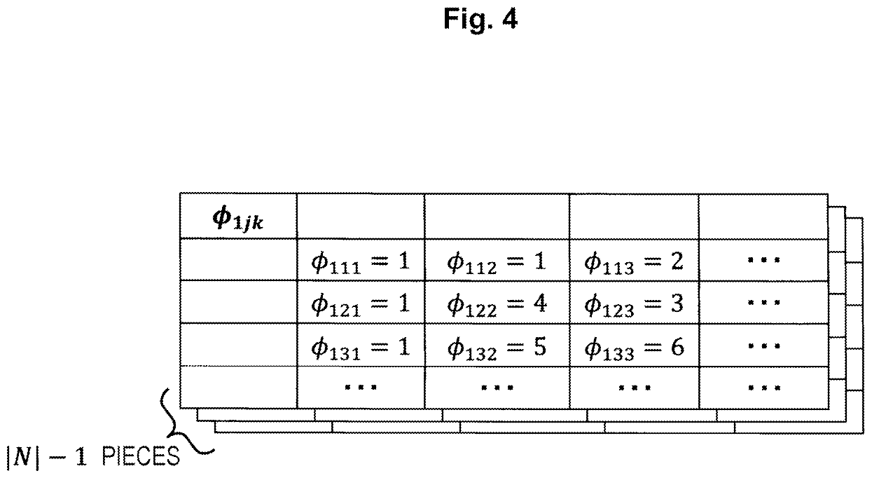

The potential storage unit 201 stores potentials φᵢⱼₖ given to the MAP estimation apparatus 10. An example of potentials φᵢⱼₖ stored in the potential storage unit 201 is shown in FIG. 4. Note that i∈[|N|−1], j∈[R], and k∈[R].

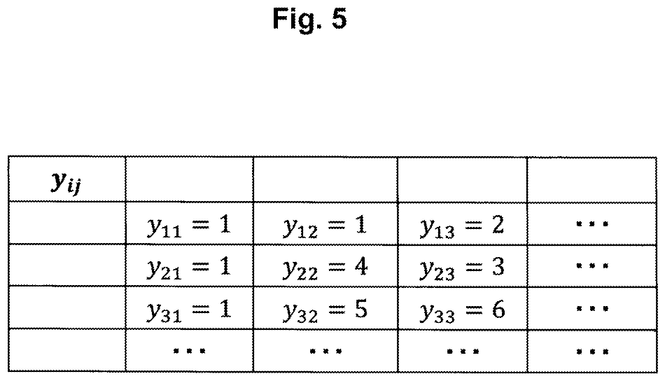

The aggregate data storage unit 202 stores aggregate data yᵢⱼ provided to the MAP estimation apparatus 10. An example of aggregate data yᵢⱼ stored in the aggregate data storage unit 202 is shown in FIG. 5.

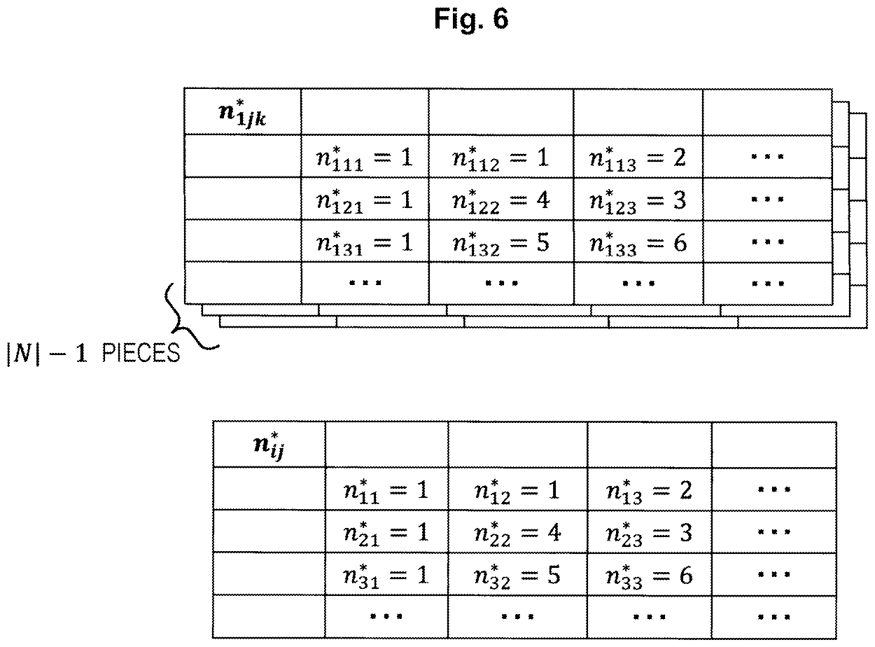

The MAP estimation solution storage unit 203 stores a MAP estimation solution n* calculated by the MAP estimation unit 103. An example of the MAP estimation solution n* stored in the MAP estimation solution storage unit 203 is shown in FIG. 6. Note that n* is a vector in which nᵢⱼₖ* and nᵢⱼ* are collected and arranged for all the vertices and all the edges.

<MAP Estimation Processing>

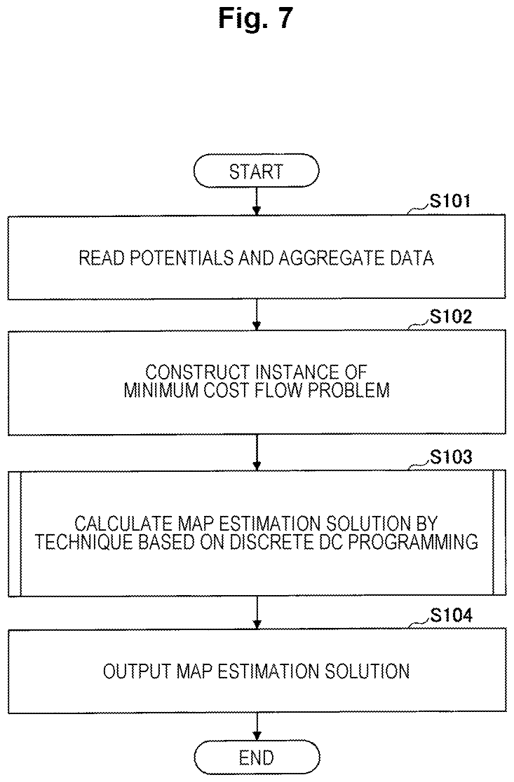

Next, a flow of MAP estimation processing according to the present embodiment is described with reference to FIG. 7. FIG. 7 is a flowchart showing an example of MAP estimation processing according to the present embodiment.

First, the instance construction unit 102 reads potentials φᵢⱼₖ stored in the potential storage unit 201 and aggregate data yᵢⱼ stored in the aggregate data storage unit 202 (step S101).

Next, the instance construction unit 102 constructs an instance of a minimum cost flow problem on the graph G=(V, E) on the basis of (a) to (g) above by using the potentials φᵢⱼₖ and the aggregate data yᵢⱼ read in step S101 above (step S102).

Next, the MAP estimation unit 103 solves the minimum cost flow problem constructed in step S102 above by a technique based on discrete DC programming, and calculates a MAP estimation solution (step S103). The MAP estimation solution calculated by the MAP estimation unit 103 is stored in the MAP estimation solution storage unit 203. Details of the processing of step S103 will be described later.

Then, the output unit 104 outputs the MAP estimation solution stored in the MAP estimation solution storage unit 203 to an arbitrary output destination (step S104). Examples of the output destination of the MAP estimation solution include another device or program connected via a communication network, the display device 12 such as a display, etc.

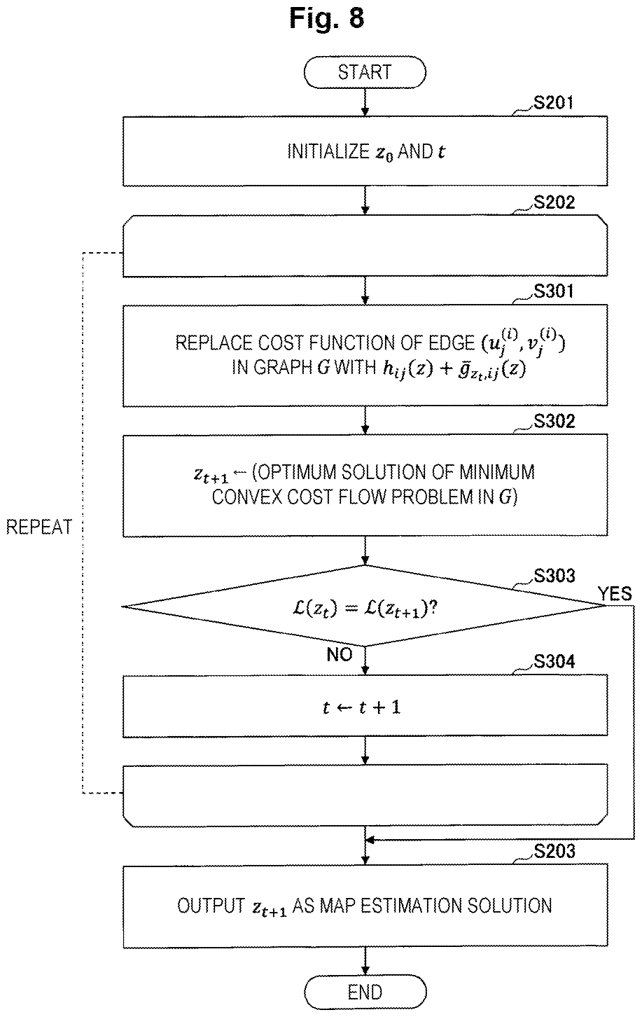

Here, the processing of step S102 above (the processing of calculating a MAP estimation solution by a technique based on discrete DC programming) is described with reference to FIG. 8. FIG. 8 is a flowchart showing an example of the processing of calculating a MAP estimation solution by a technique based on discrete DC programming according to the present embodiment.

First, the MAP estimation unit 103 performs initialization of z₀←0 and t←0 (step S201).

Next, the MAP estimation unit 103 executes the processing of repeating step S301 to step S304 below (step S202). This repetition processing is repeatedly executed until YES is obtained as decision in step S303.

The correction unit 111 of the MAP estimation unit 103 replaces the cost function of an edge stretched from vertex uⱼ⁽ⁱ⁾ to vertex vⱼ⁽ⁱ⁾ in graph G with

hᵢⱼ(z)+g̅_{z}_{_{t, ij}}(z) [Math. 42]

(step S301).

Next, the capacity scaling unit 112 of the MAP estimation unit 103 solves the minimum convex cost flow problem shown in Math. 30 above by capacity scaling, and calculates a solution zₜ₊₁ (step S302). Note that the capacity scaling is an algorithm for efficiently solving the minimum convex cost flow problem (see, for example, Reference 3).

Reference 3: R. K. Ahuja, T. L. Magnanti, J. B. Orlin, Network Flows: Theory, Algorithms, Applications, Prentice Hall, 1993.

Next, the MAP estimation unit 103 decides whether

[symbol]

(zₜ)= [symbol] (zₜ₊₁) [Math. 43]

is satisfied or not (step S303). That is, the MAP estimation unit 103 decides whether the solution zₜ₊₁ has converged or not.

In the case where it is not decided in step S303 above that the solution zₜ₊₁ has converged (NO in step S303), the MAP estimation unit 103 sets t←t+1 (step S304), and then returns to step S301. On the other hand, in the case where it is decided in step S303 above that the solution zₜ₊1 has converged (YES in step S303), the MAP estimation unit 103 outputs (stores) the solution zₜ₊₁ as a map estimation solution n* to the MAP estimation solution storage unit 203 (step S203).

The present invention is not limited to the above specifically disclosed embodiment, and various modifications and changes, combinations with known technologies, etc. can be made without departing from the scope of the claims.

### REFERENCE SIGNS LIST

10 MAP estimation apparatus
11 Input device
12 Display device
13 External I/F
13a Recording medium
14 Communication I/F
15 Processor
16 Memory device
17 Bus
101 Input unit
102 Instance construction unit
103 MAP estimation unit
104 Output unit
111 Correction unit
112 Capacity scaling unit
201 Potential storage unit
202 Aggregate data storage unit
203 MAP estimation solution storage unit

1. An estimation method that estimates a maximum a posteriori (MAP) solution of a collective graphical model (CGM) on a path graph,
wherein a computer executes:
receiving, as inputs, aggregate data and potentials of the CGM on the path graph;
solving a MAP estimation problem of the CGM by a technique based on discrete DC programming using the aggregate data and the potentials, and calculating a MAP estimation solution; and
outputting the MAP estimation solution.

2. The estimation method according to claim 1, wherein
in the solving of the MAP estimation problem of the CGM, a minimum cost flow problem is constructed using the aggregate data and the potentials, and the minimum cost flow problem is solved by the technique based on the discrete DC programming.

3. The estimation method according to claim 2, wherein
in the calculating of the MAP estimation solution, correction of a cost function on a network targeted by the minimum cost flow problem and calculation of an optimum solution of a minimum convex cost flow problem using a corrected cost function, by the technique based on the discrete DC programming, is repeated.

4. An estimation apparatus that estimates a MAP solution of a CGM on a path graph,
the apparatus comprising:
a memory; and
a processor coupled to the memory and configured to:
receive, as inputs, aggregate data and potentials of the CGM on the path graph;
solve a MAP estimation problem of the CGM by a technique based on discrete DC programming using the aggregate data and the potentials, and calculate a MAP estimation solution; and
output the MAP estimation solution.

5. A non-transitory computer-readable recording medium storing a program that causes a computer to execute the estimation method according to claim 1.
